(19) United States
(12) Patent Application Publication
(10) Pub. No.: US 2024/0142137 A1
(43) Pub. Date: May 2, 2024

(54) Electrical Heating Device with a Hold-Down Device

(71) Applicant: Eberspächer catem GmbH & Co. KG, Herxheim (DE)

(72) Inventors: Ralf Lothar Weinand, Wörth am Rhein (DE); Kai-Fabian Bürkle, Hinterweidenthal (DE); Simon Georg Kräck, Karlsruhe (DE)

(21) Appl. No.: 18/384,111

(22) Filed: Oct. 26, 2023

(30) Foreign Application Priority Data
Oct. 26, 2022 (DE) 10 2022 128 348.8

(51) Int. Cl. F24H 3/04; F24H 9/20

(52) U.S. Cl. CPC F24H 3/0429; F24H 9/2071

(57) ABSTRACT

A heating device comprises a circulation chamber with inlet and outlet openings for a heat carrier, a heating assembly connected to the circulation chamber in a heat-conducting manner for heating the heat carrier in the circulation chamber, a connection chamber with a control unit arranged therein and comprising a printed circuit board for controlling the PTC heating assembly, a partition wall between the circulation chamber and the connection chamber, and a hold-down device arranged on the side of the control unit facing away from the partition wall which interacts with the control unit. For an improved protection of the electrical heating device the hold-down device incorporates measures for collecting moisture, which are configured such that condensed moisture is kept away from the control unit, at least in certain areas.

### BACKGROUND OF THE INVENTION

### 1. Field of the Invention

The present invention relates to an electrical heating device comprising a circulating chamber having inlet and outlet openings for a heat carrier, a heating assembly, in particular a PTC heating assembly connected to the circulating chamber in a heat-conducting manner with a PTC element for heating the heat carrier in the circulating chamber, a connection chamber with a control unit arranged therein and comprising a printed circuit board for controlling the heating assembly, a partition wall between the circulation chamber and the connection chamber, and a hold-down device arranged on the side of the control unit facing away from the partition wall, which interacts with the control unit, for example by pressing the control unit toward the partition wall.

### 2. Background of Related Art

EP 2 466 989 A1 discloses a generic electrical heating device. Here, the hold-down device, called the support structure, interacts with the control unit in that the hold-down device indirectly applies pressure to the control unit so that the control unit abuts better against the partition wall and can dissipate waste heat to the partition wall.

The connection chamber may contain moisture, for example in the air contained therein, thus humidity. Due to temperature fluctuations, in particular temperature gradients, within the connection chamber, at least some of this moisture can condense out and then precipitate in liquid form in the connection chamber. During operation of the heating assembly, such temperature fluctuations or temperature gradients can occur because an area close to the heating assembly, in particular at the partition wall, can be heated rapidly. In particular, at a wall or cover away from the partition wall or the heating assembly, there may then be a comparatively low temperature, and this may lead to the condensation out of the moisture. If the control unit comes into contact with moisture—in particular in the liquid form—there is a risk of defect of the control unit.

The underlying problem of the present invention is to provide improved protection for the control unit in the electrical heating device, in particular to protect it from moisture.

### SUMMARY

In order to solve this problem, the present invention proposes an electrical heating device comprising, a circulation chamber with inlet and outlet openings which are configured to receive a heat carrier, an electric heating assembly that is connected to the circulation chamber in a heat-conducting manner, the electric heating assembly being configured to heat the heat carrier in the circulation chamber, a connection chamber that has a control unit arranged therein, the control unit comprising a printed circuit board for controlling the heating assembly, a partition wall that is located between the circulation chamber and the connection chamber, and a hold-down device. The hold-down device is arranged on a side of the control unit facing away from the partition wall which interacts with the control unit. The hold-down device comprises means for collecting moisture, which means is configured such that condensed moisture is kept away from the control unit, at least in certain areas. In this respect, the means can intercept the moisture dripping in the direction of the control unit and discharge it collected laterally next to the hold-down device. Accordingly, the moisture is initially stopped on the side of the hold-down device facing away from the control unit and is discharged collected at one or more specific areas on or next to the control unit. Alternatively or additionally, collecting can be effected by the moisture being collected by the hold-down device and kept or stored there. In this context, it has been shown that a corresponding reservoir containing, for example, a drying agent is taught again by the operation of the electrical heating device. The reservoir can absorb the moisture and discharge it again due to the heating of the electrical heating device during operation. In other words, the drying agent is regenerated by the operation of the electrical heating device. In this regard, the reservoir is sized so that it can store the condensate that normally occurs within the connection chamber. The means may include a groove and/or a roof surface for keeping moisture away from the control unit.

In other words, an improved heating device is proposed in which—in particular on a comparatively cold cover or cold wall—condensed water and/or humidity can be kept away from the control unit in an improved manner. This can be achieved in that the control unit is protected from contact with the moisture by the hold-down device by the groove and/or the roof surface located thereon or therein.

In this context, the hold-down device extends at least over a certain surface area of the control unit, usually the printed circuit board, such that the areas of the control unit that are particularly susceptible to moisture are covered by the hold-down device. The hold-down device may be located in a generally known manner between the control unit and the cover, which usually extends parallel to the partition wall. Condensed moisture dripping from the cover is collected and discharged and/or stored by the hold-down device, and in any case from those surface areas of the printed circuit board which are particularly susceptible to moisture. This includes, for example, soldering areas or points or contact points exposed on the printed circuit board, in particular for contacting with the power current, which can have a voltage of significantly more than 200 V up to 800 V or more. In the earth's gravitational field, the electrical heating device is usually aligned in such a way that the hold-down device is provided above the control device. In the earth's gravity field, the cover or other wall of the connection chamber may be located above the hold-down device. In other words, the condensate dripping from the cover does not fall onto the control unit, or the areas of the control unit that are particularly susceptible to moisture, but onto the hold-down device.

With the invention it has been recognized that the hold-down device can be complementarily used to protect the heating device or the control unit from moisture. The typical function of the hold-down device—applying pressure to the control unit—is in this respect complemented by a function of guiding liquid in the groove and/or keeping away drops by way of the roof surface at least partially covering the control unit. With little effort, a previously known hold-down device can thus be complemented by features according to the invention or described herein and the heating device can be improved.

The connection chamber can be closed via any/the wall or any/the cover of the electrical heating device. In particular and at least substantially, the wall ensures that the connection chamber is sealed and that pressure is applied to the hold-down device. The wall may have an embossing. The embossing may correspond to the hold-down device, in particular the groove, to form a positive fit therewith. The embossing can serve to stabilize the wall.

The groove and/or roof surface can effectively drain or keep moisture away from the control unit. The groove can be used to direct the moisture. For example, to areas less susceptible to the moisture, such as an area remote from the control unit. Drops can land on the roof surface that might otherwise have landed on the control unit. Thus, the hold-down device can have a dual function when the groove or roof surface according to the invention is added to the hold-down device: It can apply pressure to the control unit to improve the cooling of the same, and it can protect the control unit from the moisture.

Any or the groove can be U-shaped or V-shaped in cross-section. In particular, the groove is open in cross-section in one direction, so that liquid can be introduced into the groove at least from this direction, for example to be conducted by the groove. Thanks to the groove, material can also be saved at the hold-down device. Thanks to its volume, the groove in this form serves not only to keep away and/or guide the moisture, but also in particular to store and retain the moisture, for example until the moisture has evaporated again.

A roof surface is understood to be, in particular, a two-dimensionally elongated surface, the core task of which is to cover the control unit over an area. For example, if the ratio of the average side length of a section of the hold-down device to its thickness is in the range above 2, 3, 4 or 5, a roof surface can be said to exist. A roof surface can be said to exist if sections of the hold-down device are longer and wider than is actually required for stability reasons in order to perform the typical task of the hold-down device—to apply pressure to the control unit.

The roof surface and/or the groove is preferably arranged, at least substantially and/or in sections, parallel to the printed circuit board. In this way, the best possible protection from the moisture can be enabled, because the groove and/or roof surface can protect a large distance and/or area of the printed circuit board.

The flow path for the condensate, possibly formed by the hold-down device, can transfer same into a reservoir of a hygroscopic drying agent due to gravity or capillary action. This can be formed within the connection chamber. It can also be formed by the hold-down device itself. Thus, the roof surface may have a depression. This depression may be for the hygroscopic drying agent. The hold-down device or the depression can comprise the drying agent. Via this, the drying agent can collect or absorb the moisture contained particularly in the air. The depression should be formed large enough to accommodate the typically pourable, granular drying agent in an amount sufficient relative to the size of the connection chamber. Thus, the depression can trap or keep away moisture, for example, in liquid form or bound via in the drying agent to be provided therein.

Multiple roof surfaces can also be provided in order to selectively protect the control unit without requiring too much material.

The roof surface and/or another roof surface may have a through-opening, for example for a pin, in particular for centering.

The heat carrier may be a fluid, in particular gaseous and/or liquid. The heat carrier may comprise water, oil and/or air or at least essentially consist thereof. Other substances are also conceivable. In particular, the invention relates to an electrical heating device for heating water, oil and/or air by way of a flow through the circulation chamber.

The hold-down device can comprise or be made of plastic and/or metal. Both materials are easy to produce in large quantities using a casting process, such as die casting or injection molding. The materials can also be produced by separating methods to achieve a good tightness and precision of the groove and/or the roof surface.

The electrical heating device is typically provided for vehicles. For example, for land vehicles, sea vehicles or aircraft.

The roof surface and/or the depression may be provided aligned facing away from the printed circuit board. The roof surface and/or the depression may alternatively or additionally be covered for fixing the drying agent. The roof surface is typically spaced apart from the printed circuit board. The depression may be formed open facing away from the printed circuit board and may be formed closed towards the printed circuit board, in particular to provide a possibility for accommodating drying agent. Thus, the drying agent can be easily introduced into the heating device. Likewise, the drying agent can be placed with repeatable accuracy because the depression creates a containment. But also moisture can be well guided in the depression.

The roof surface and/or depression may be provided adjacent a first section of the groove and adjacent a second section of the groove. In particular, if the roof surface and/or depression and also the groove are provided, a particularly good protection against moisture can be provided. The sections generally differ in that they are aligned and/or formed differently. Against this background, it makes sense that several sections of the groove are provided, wherein the depression is adjacent to at least two of these sections. This mechanically stabilizes the hold-down device and allows moisture to be kept away or absorbed over a large area. The mechanical stability is particularly helpful when the roof surface is used for the drying agent.

The groove may be arranged in any/the first section facing away from the printed circuit board and/or is covered at least in sections to form a channel for the moisture. When the groove is facing away from the printed circuit board, it is formed closed to the printed circuit board and thus can guide moisture away from the printed circuit board and thus protect the printed circuit board from the moisture. In particular, the groove in this arrangement can be easily covered, for example by any/the wall or any/the cover to close the connection chamber, for example to form the channel.

The groove may have a second and/or a third section arranged facing away from the printed circuit board and/or covered at least in sections to form any or the channel for moisture. The sections generally differ in that they are aligned and/or formed differently. Thus, the moisture can be effectively kept away from the printed circuit board. The grooves can thus also be easily covered to form the channel.

It may be provided that the first section, the second section and/or the third section are at least substantially straight. The sections may extend at least substantially in one plane. Thus, the moisture can be absorbed from different areas in the connection chamber. Likewise, in particular by way of gravity and/or a capillary force in the respective section, the moisture can thus be directed into one or more areas of the connection chamber. The various areas include, for example, critical areas on the printed circuit board where moisture must be particularly kept away, for example in the area of power transistors and/or high-voltage components.

The three sections may merge at a common interface and/or are arranged in a Y-shape or star shape and/or at an angle to each other. Thus, it is possible to protect a large area from the moisture without the component having to become very large and thus expensive or difficult to assemble. The sections can thus open up a kind of funnel that can collect the moisture in liquid form. In particular, the moisture can be directed into a section that is, for example, the lowest section.

It may be provided that the groove has an absorption area for absorbing the moisture in liquid form. The absorption area is to be understood, for example, as a lateral opening on the groove. In particular, the absorption area is to be aligned and configured such that it is adapted to absorb—for example on the wall or on the cover of the connection chamber—liquid, in particular flowing liquid, into the groove. The absorption area can have a funnel shape and/or a recess. The absorption area can also be configured as an aperture of the hold-down device, in particular of the groove, and/or comprise the same. The aperture can exert a capillary action on the moisture, so that moisture located in the vicinity can be drawn in by the capillary action. For this purpose, the aperture must be configured to be comparatively small, for example having a diameter of at most 1 mm, 0.75 mm or 0.5 mm. The hold-down device can also comprise several of the apertures. In particular, to prevent clogging, but nonetheless to achieve capillary action, multiple apertures may be provided adjacent to each other. One or more apertures may also be arranged in each of several or each of several sections of the groove. The aperture may also be arranged at the interface between two sections. An aperture may also be arranged between each pair of two sections. Then the hold-down device can absorb moisture well in different installation positions or orientations.

The hold-down device may have a baffle wall, at least in the absorption area. The baffle wall is to be understood in particular in the sense of a roof surface or further roof surface, which should be spaced apart from both the printed circuit board and a/the wall or cover of the connection chamber. The baffle wall is good at keeping moisture away from the printed circuit board as well as efficiently guiding moisture into the groove.

Alternatively or additionally, it is possible for the hold-down device to have a shoulder at least in the absorption area. The shoulder may be arranged in sections circumferentially on the groove. The shoulder may extend around at least one, several or all sections of the groove. In interaction with the wall or the cover, the shoulder can provide a further groove in which moisture—in particular in the absorption area—can be held.

The groove may comprise a dispensing area for dispensing the moisture in liquid form. The dispensing area may be a side opening or recess on the groove. In particular, the dispensing area is to be aligned and configured to dispense flowing liquid from the groove. Likewise, the dispensing area may be provided with any and/or with the aforementioned aperture. In particular, the dispensing area is provided at an end of a groove or section. Thus, gravity can be well utilized to dispense moisture. This can also prevent a moisture nest from accumulating in the groove, which can lead to corrosion.

It may be provided that the hold-down device has through-openings for centering the hold-down device relative to the printed circuit board. Pins may be provided for centering the hold-down device with respect to the printed circuit board. The pins may project from or be arranged on the printed circuit board and/or the partition wall. The through-openings may correspond to the pins. Thus, the hold-down device can be fixed relative to the printed circuit board and/or relative to the partition wall. The printed circuit board and the hold-down device can be attached to the pins. This ensures that the hold-down device is arranged in the correct position relative to the printed circuit board so that it can always safely keep moisture away.

In particular, the through-openings run approximately centrally through a respective section. Thus, there is the lowest possible risk of the through-openings forming a starting point for fatigue cracks.

The groove, at least in the area of the through-openings, may be curved to bypass the through-openings. Then the through-openings can be placed as centrally as possible in the section without the groove leaking towards the printed circuit board at this point.

Elastic elements may be provided between the hold-down device and the printed circuit board. For example, an elastic element comprises plastic, elastomer, raw rubber and/or vulcanized rubber in order to be compressible. Via the elastic elements, the hold-down device can apply a compressive force to power transistors so that they are well pressed against the partition wall. This allows the power transistors to dissipate their waste heat well, wherein manufacturing tolerances are compensated for in an improved manner.

The hold-down device may be a cold-pressed part. According to this, the hold-down device is formed from a sheet metal. Due to the cold pressing process, this hold-down device has a high strength with a relatively low dead weight. With a moderate degree of forming, which is sufficient, for example, for the formation of strength-increasing ribs or edges, such a hold-down device can be produced inexpensively but with high dimensional accuracy. Depending on the desired strength requirements, the sheet forming the hold-down device can have varying wall thicknesses over the spatial extent of the hold-down device, which enables a further weight-saving design to be achieved.

In the context of the disclosure described above and below, the term “or” stands as a short form for “and/or” and is basically intended to indicate alternative, basically equivalent and/or synonymous features or terms in order to bring the idea or meaning of a feature or term usage closer. “Or” can always be replaced with “and/or”.

### BRIEF DESCRIPTION OF THE DRAWINGS

Further details and advantages of the present invention will be apparent from the following description of an embodiment in conjunction with the drawing. Therein:

FIG. 1A shows the connection chamber of an electrical heating device with several PTC heating devices with a view on a printed circuit board of a control unit and a hold-down device in a perspective view,

FIG. 1B shows a sectional side view of the electrical heating device of FIG. 1A closed with a cover,

FIG. 1C shows the hold-down device of FIG. 1A in a top view,

FIG. 2 shows another hold-down device of an electrical heating device in a perspective view,

FIGS. 3A-B shows a third hold-down device of an electrical heating device with a roof surface having a depression for a drying agent (A) and with the drying agent (B) accommodated in the depression in a perspective view.

### DETAILED DESCRIPTION

In the following, the invention is described according to several embodiments. The individual embodiments differ in part only by a few features. In this respect, not every feature is described again in order to avoid repetition. Therefore, in particular, the description given for the respective reference sign applies universally to all embodiments.

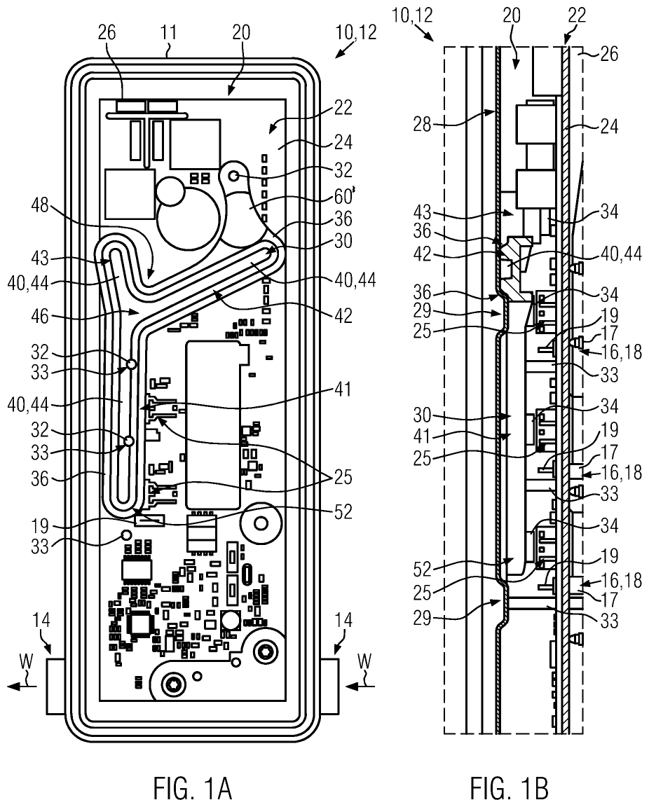

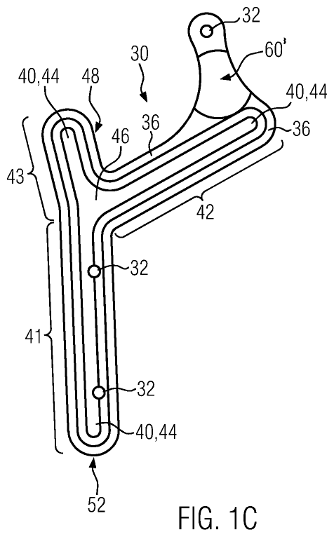

FIG. 1A-B shows an electrical heating device 10 according to the invention with a hold-down device 30. The hold-down device 30 is shown individually in FIG. 1C.

The heating device 10 has a heater housing 11 in which a circulation chamber 12 and a connection chamber 20 are arranged side by side and separated by a partition wall 26. The heating device 10 is shown facing the connection chamber 20 and the partition wall 26. In FIG. 1A, the circulation chamber 12 with inlet and outlet openings 14 is arranged facing away from the connection chamber 20 and therefore rearwardly.

A printed circuit board 24 of a control unit 22 is arranged in the connection chamber 20, wherein a hold-down device 30 is arranged on the printed circuit board 24. The heating device typically, but not necessarily, installed with the hold-down device facing upwardly and the printed circuit board 24 being positioned beneath the hold down device 30. Below the printed circuit board 24—into the image plane—the partition wall 26 is arranged. The partition wall 26 separates the connection chamber 20 from the circulation chamber 12, in which a heat carrier W guided therethrough can be heated by a plurality of PTC heating assemblies 16 controllable by the control unit 22. The heat carrier W may be guided through the circulation chamber 12 via the inlet and outlet openings 14. Frontwardly, and specifically on the side of the printed circuit board 24 facing away from the partition wall 26, the hold-down device 30 is arranged.

The hold-down device 30 has a groove 40 which is divided into three sections 41, 42, 43. The three sections 41, 42, 43 are arranged in a Y-shape or star shape relative to one another and each run at least substantially straight.

A first section 41 extends along the printed circuit board 24 above three power transistors of the control unit 22. Two through-openings 32 for pins 33 are arranged in the first section 41.

A second section 42 extends obliquely with respect to the first section 41. Adjacent to the second section 42, a roof surface indicated by reference sign 60′, also referred to as further roof surface 60′, covers a portion of the printed circuit board 24 to keep fluid F away. This (further) roof surface 60′ further also comprises a through-opening 32.

A third section 43 of the groove 40 makes the hold-down device 30 Y-shaped or star-shaped because the third section 43 is adjacent to the interface 46 from the first and second sections 41, 42. Further, the third section 43 is also arranged obliquely with respect to the first section 41. All sections 41, 42, 43 lie in one plane.

The sectional view of FIG. 1B shows that the hold-down device 30 interacts with the control unit 22. The hold-down device 30 is provided to abut the printed circuit board 24 at least indirectly and, in particular, to press against the printed circuit board 24. For this purpose, a wall 28 or a cover which closes an upper surface of the connection chamber 20 abuts the top surface of the hold-down device 30. The wall 28 exerts a force on the hold-down device 30 in the direction of the control unit 22. The force is transmitted to the power transistors 25 via elastic elements 34, so that the power transistors are pressed towards the partition wall 26 for abutting there in a heat-conducting manner, in particular so that the power transistors 25 are cooled via heat dissipation to the partition wall 26

FIG. 1B further shows that contact tongues 19 of the PTC heating assemblies 16, i.e. the individual PTC heating elements 18, protrude through the printed circuit board 24 and are thus electrically contacted. The PTC heating assemblies 16 are inserted in the partition wall 26. A housing 17 of the PTC heating assembly 16 protruding into the circulation chamber 12 for each PTC heating assembly 16 respectively contains one of the PTC heating elements 18. In this context, the individual PTC heating elements 18 are electrically insulated from their housings 17 and are inserted into the circulation chamber 13 through the housings 17 in a fluid-tight manner Thereby, the PTC heating elements 18 are applied to the housings 17 from the inside in a heat-conducting manner in order to be able to dissipate heat to the heat carrier W.

The pins 33 project from the partition wall 26 toward the connection chamber 20. The printed circuit board 24 is plugged onto the pins 33, and in addition, the hold-down device 30 with its through-openings 32 is plugged thereon. Thus, the hold-down device is centered relative to the printed circuit board 24 and, in particular, is centered relative to the wall 28.

FIG. 1B also shows that the groove 40 is covered by the wall 28. Thus, a channel 44 is formed.

In the process, the wall 28 just does not have to abut the hold-down device 30 in a completely fluid-tight manner, so that moisture F can enter the channel 44 in liquid form, particularly in the area of the interface 46, or can leave the channel 44 at a lower point, for example a dispensing area 52.

In the present case, the wall 28 has an embossing 29 which corresponds to a shoulder 36 of the hold-down device 30, i.e. at least in sections abuts the shoulder 36 in a formfitting manner. In this way, both a certain sealing of the channel 44 and a large-area abutment of the wall 28 against the hold-down device 30, which is gentle on the material, can be ensured.

FIG. 1C shows the individual hold-down device 30 of FIG. 1A-B. Typically, the hold-down device 30 is aligned with the first section 41 pointing downward so that an absorption area 48 for incoming moisture F is formed between the second and third sections 42, 43. The moisture F, which due to the downwardly pointing gravity force then dwells in the funnel-shaped intermediate space at reference sign 48, can gradually penetrate laterally into the groove 40 or the channel 44 typically formed with the wall 28. However, this does not necessarily have to occur in this manner. For example, the moisture F may also dwell in the absorption area 48 until it evaporates.

The shoulder 36 extends around all sections 41, 42, 43 or the entire groove 40. The shoulder 36, in interaction with the wall 28, provides another groove in which moisture F can be held, particularly in the absorption area 48.

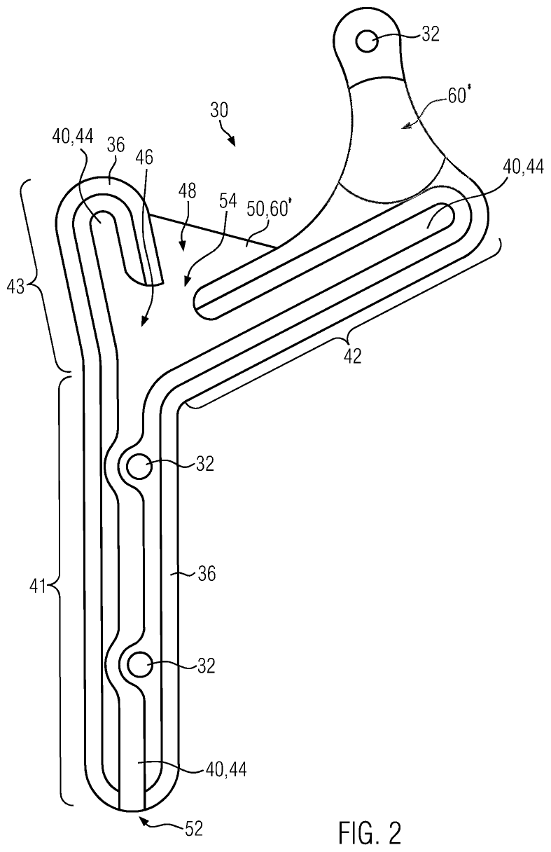

FIG. 2 shows a further hold-down device 30 of an electrical heating device 10. Compared with the hold-down device 30 of FIGS. 1A-C, the hold-down device 30 of FIG. 2 is modified in that the absorption area 48 has a baffle wall 50 which also acts in the sense of a (further) roof surface 60′. Thus, a larger quantity of liquid moisture F can be prevented from overflowing from the hold-down device 30. In fact, the baffle wall 50 forms an intermediate space between the wall 28. In addition, the hold-down device 30 of FIG. 2 is modified in that an aperture 54 is provided at the absorption area 48 to allow moisture F to enter the groove 40 with the least possible resistance, particularly laterally.

In FIG. 2—in contrast to the hold-down device 30 of FIGS. 1A-C—it is further apparent that the groove 40 is curved, bypassing the two through-openings 32 in the first section 41. Thus, the groove 40 is closed on the part of the control unit 22 and the liquid F is directed, if possible, only along the first section 41, which typically points downward.

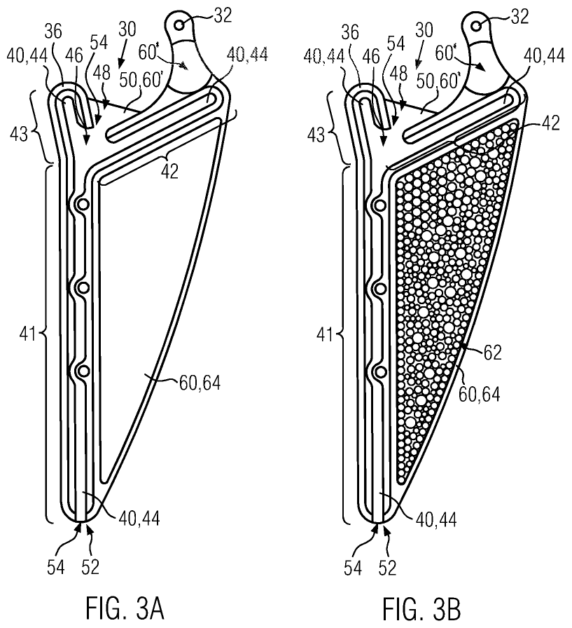

FIGS. 3A-B show a further hold-down device 30 of an electrical heating device which has been further modified compared to the hold-down device 30 of FIG. 2 described above. In this respect, the hold-down device 30 has an enlarged elongated first section 41, in particular the first section 41 is at least twice as long as the second section 42. The hold-down device 30 is further Y-shaped or star-shaped. The first section 41 now has three through-openings 32 which are bypassed by the groove 40. In addition, the dispensing area 52 is provided with an aperture 54 so that the moisture F can pass through the aperture 54 with as little resistance as possible.

Furthermore, the hold-down device 30 of FIGS. 3A-B is modified compared to the hold-down device 30 of FIG. 2 in that—in addition to the (further) roof surface 60′—a particularly approximately triangular roof surface 60 is provided between the first section 41 and the second section 42. In this respect, roof surface 60 and depression 64 are adjacent to the first section 41 and to the second section 42 of the groove 40.

The roof surface 60 comprises the depression 64, wherein the depression 64 faces out of the image plane toward the viewer. In this respect, when the hold-down device is installed in a heater housing 11, this depression 64 is aligned away from the partition wall 26, the control unit 22 and the printed circuit board 24. This allows liquid moisture F to collect therein, if necessary. However, it is also possible to place a drying agent 62 in the depression 64 and fix it in place thanks to the depression 64.

In FIG. 3B, compared to FIG. 3A, a hygroscopic drying agent 62 is added. The drying agent 62 is introduced into the depression 64. In interaction with the wall 28, the drying agent 62 can then be held or fixed in the depression in that the wall 28 covers the depression 64. A narrow circumferential gap between wall 28 and the edge of the depression 64 may then be sufficient to allow the drying agent to absorb moisture F from the air contained in the connection chamber 20. In this respect, the roof surface 60 may also serve to keep moisture F away from the control unit 22 by absorbing the moisture in the air.

1. An electrical heating device comprising:
a circulation chamber with inlet and outlet openings which are configured to receive a heat carrier;
an electric heating assembly that is connected to the circulation chamber in a heat-conducting manner, the electric heating assembly being configured to heat the heat carrier in the circulation chamber;
a connection chamber that has a control unit arranged therein, the control unit comprising a printed circuit board for controlling the heating assembly;
a partition wall that is located between the circulation chamber and the connection chamber; and
a hold-down device that is arranged on a side of the control unit facing away from the partition wall which interacts with the control unit, wherein the hold-down device comprises means for collecting moisture, which means is configured such that condensed moisture is kept away from the control unit, at least in certain areas of the control unit.

2. The electrical heating device according to claim 1, wherein the means includes a groove and/or a roof surface.

3. The electrical heating device according to claim 1, wherein the means includes a roof surface that comprises a depression for receiving a hygroscopic drying agent for absorbing the moisture.

4. The electrical heating device according to claim 3, wherein the roof surface and/or the depression is aligned facing away from the printed circuit board and/or is covered for fixing the drying agent.

5. The electrical heating device according to claim 1, wherein the means comprises a groove having first and second sections and a roof surface having a depression for receiving a hygroscopic drying agent for absorbing the moisture, and wherein the roof surface and/or the depression is adjacent to the first section of the groove and to the second section of the groove.

6. The electrical heating device according to claim 1, wherein the means comprises a groove, and wherein at least a first section of the groove is arranged facing away from the printed circuit board and/or is covered at least in sections to form a channel for the moisture.

7. The electrical heating device according to claim 6, wherein the groove comprises a second section and/or a third section arranged facing away from the printed circuit board and/or covered at least in sections for forming the channel for the moisture.

8. The electrical heating device according to claim 7, wherein the first section, the second section and/or the third section of the groove are at least substantially straight.

9. The electrical heating device according to claim 7, wherein the first, second, and third sections of the groove merge into one another at a common interface and/or are arranged in a Y-shape and/or obliquely relative to one another.

10. The electrical heating device according to claim 1, wherein the means comprises a groove, and wherein the groove comprises an absorption area.

11. The electrical heating device according to claim 10, wherein the hold-down device comprises, at least in the absorption area, a baffle and/or a shoulder.

12. The electrical heating device according to claim 1, wherein the means comprises a groove including a dispensing area.

13. The electrical heating device according to claim 1, wherein, for centering the hold-down device with respect to the printed circuit board, the hold-down device comprises through-openings and/or the printed circuit board comprises pins.

14. The electrical heating device according to claim 13, wherein the groove, at least in the area of through-openings, is curved to bypass the through-openings.

15. The electrical heating device according to claim 1, wherein the hold-down device comprises a cold-pressed part.

16. The electrical heating device according to claim 1, further comprising a wall which is located above hold-down device and which closes an upper surface of the connection chamber.

17. An electrical heating device comprising:
a circulation chamber with inlet and outlet openings which are configured to receive a heat carrier;
an electric heating assembly that is connected to the circulation chamber in a heat-conducting manner, the electric heating assembly being configured to heat the heat carrier in the circulation chamber;
a connection chamber;
a partition wall that is located between the circulation chamber and the connection chamber; and
a control unit that is arranged in the connection chamber above the partition wall, the control unit comprising a printed circuit board for controlling the heating assembly;
a hold-down device that is arranged on an upper side of the control unit; and
a wall which is located above hold-down device and which closes an upper surface of the connection chamber;
wherein the hold-down device is provided with at least one of
a groove which is formed in an upper surface of the hold-down device and which is configured to collect condensed moisture and to keep moisture away from the printed circuit board,
a roof surface which is formed in the upper surface of the hold-down device and which has a depression which is configured to collect condensed moisture and to keep the condensed moisture away from the printed circuit board.

18. The electrical heating device according to claim 17, further comprising a hygroscopic drying agent located in the depression chamber.

19. The electrical heating device according to claim 17, wherein the hold-down device is provided with both the groove and the roof structure with the depression.

20. The electrical heating device according to claim 17, wherein the hold-down device is provided with the groove, and wherein the groove has first, second, and third sections collectively forming generally the shape of a Y when viewed from above, and wherein an absorption area is located between the second and third sections of the groove.
